(19) United States
(12) Patent Application Publication
(10) Pub. No.: US 2021/0326560 A1
(43) Pub. Date: Oct. 21, 2021

(54) MOBILE TERMINAL AND RECOGNITION METHOD

(71) Applicant: Vivo Mobile Communication Co., Ltd., Chang'an Dongguan (CN)

(72) Inventor: Jinshan Ye, Chang'an Dongguan (CN)

(73) Assignee: Vivo Mobile Communication Co., Ltd., Chang'an Dongguan (CN)

(21) Appl. No.: 17/360,525

(22) Filed: Jun. 28, 2021

Related U.S. Application Data
(63) Continuation of application No. PCT/CN2019/126282, filed on Dec. 18, 2019.

(30) Foreign Application Priority Data
Dec. 28, 2018 (CN) 201811620728.9

(51) Int. Cl. G06K 9/00; G06K 9/20; G06F 3/14

(52) U.S. Cl. CPC G06K 9/0004; H04M 1/72463; G06F 3/1423; G06K 9/2027

(57) ABSTRACT

A mobile terminal and a recognition method are provided. The mobile terminal includes a first display panel (21), where the first display panel (21) is a transparent piece; a second display panel (22), where the second display panel (22) is disposed facing away from the first display panel (21), and the second display panel (22) is a transparent piece; a recognition module (23), where the recognition module (23) is disposed between the first display panel (21) and the second display panel (22); and a light adjustment piece (24), where the light adjustment piece (24) is disposed between the first display panel (21) and the second display panel (22), and reflects light entering from the first display panel (21) and the second display panel (22) to the recognition module (23).

### CROSS-REFERENCE TO RELATED APPLICATIONS

This application is a continuation application of a PCT Application No. PCT/CN2019/126282 filed on Dec. 18, 2019, which claims priority to Chinese Patent Application No. 201811620728.9, filed in China on Dec. 28, 2018, the disclosures of which are incorporated herein by reference in their entireties.

### TECHNICAL FIELD

This disclosure relates to the field of electronics technologies, and in particular, to a mobile terminal and a recognition method.

### BACKGROUND

In the related art, for security of user information, a fingerprint recognition function is increasingly common in mobile terminals such as mobile phones. For example, the fingerprint recognition function is quite convenient and quick in screen unlocking, mobile payment (for example, WeChat payment and transfer), and the like. However, with continuous development of electronic technologies, dual-screen mobile phones with screens on the front and back have gradually become a development trend. To implement the fingerprint recognition function on both screens of the dual-screen mobile phones, two separate fingerprint module units, including two separate optical lenses, two separate fingerprint sensors, and the like, need to be disposed in a mobile phone. Undoubtedly, this greatly increases costs and occupied structural space, and a lightweight design requirement is hard to meet. Therefore, this problem needs to be urgently solved.

### SUMMARY

Embodiments of this disclosure provide a mobile terminal and a recognition method.

This disclosure is implemented as follows: a mobile terminal is provided, including:
a first display panel, where the first display panel is a transparent piece;
a second display panel, where the second display panel is disposed facing away from the first display panel, and the second display panel is a transparent piece;
a recognition module, where the recognition module is disposed between the first display panel and the second display panel; and
a light adjustment piece, where the light adjustment piece is disposed between the first display panel and the second display panel, and is configured to reflect light entering from the first display panel and the second display panel to the recognition module.

An embodiment of this disclosure further provides a recognition method applied to the mobile terminal according to any one of the above, and the method includes:
obtaining a recognition result by the recognition module of in recognizing current biometric information input;
when the recognition result indicates successful recognition, determining a target display panel to which the biometric information input is applied, where the target display panel is one of the first display panel and the second display panel; and
performing an operation function corresponding to successful recognition on the target display panel.

In the embodiments of this disclosure, the mobile terminal transmits the light entering from the first display panel and the second display panel to the recognition module through the light adjustment piece, so that biometric information recognition (for example, a fingerprint recognition function) can be implemented using one recognition module for two display panels, thereby reducing costs and occupied space.

### BRIEF DESCRIPTION OF DRAWINGS

FIG. 1 is a schematic diagram of a basic principle of a fingerprint recognition technology;

FIG. 2 is a schematic structural diagram of a mobile terminal according to an embodiment of this disclosure;

FIG. 3 is a schematic structural diagram of a light adjustment piece according to an embodiment of this disclosure; and

FIG. 4 is a flowchart of a recognition method according to an embodiment of this disclosure.

### DESCRIPTION OF EMBODIMENTS

The following clearly describes the technical solutions in the embodiments of this disclosure with reference to the accompanying drawings in the embodiments of this disclosure. Apparently, the described embodiments are merely some rather than all of the embodiments of this disclosure. All other embodiments that a person of ordinary skill in the art obtains based on the embodiments of this disclosure shall fall within the protection scope of this disclosure.

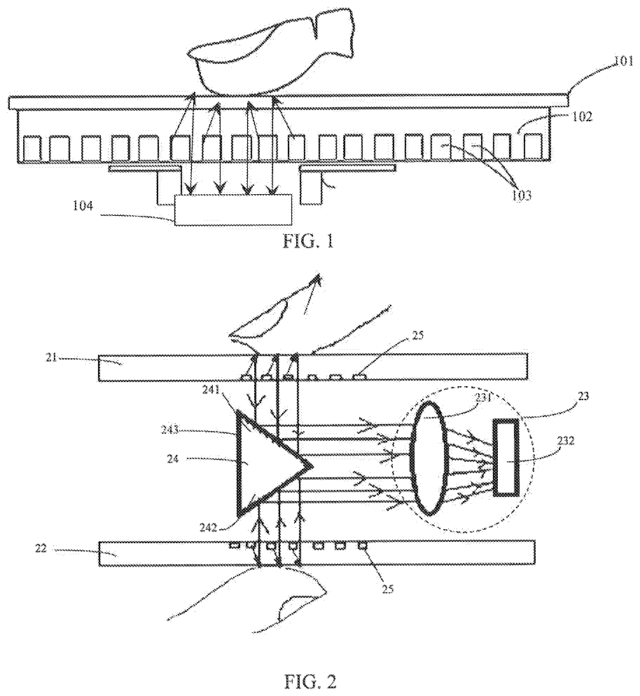

To better understand this disclosure, a basic principle of a fingerprint recognition technology in this disclosure is first described briefly. As shown in FIG. 1, a display panel includes a protective glass cover 101 and an OLED screen unit 102. A light emitting source 103 is disposed on the OLED screen unit 102. When a finger is pressed on the protective glass cover 101 of the display panel, light emitted by the light emitting source 103 is reflected by the finger and passes through the protective glass cover 101 and the OLED screen unit 102 of the display panel, and then is received by a fingerprint recognition module 104, so that a fingerprint recognition function is implemented. However, to implement the fingerprint recognition function on dual screens, two separate fingerprint recognition modules need to be disposed, greatly increasing costs and occupied space.

In some embodiments of this disclosure, as shown in FIG. 2, a mobile terminal is provided, including:
a first display panel 21, where the first display panel 21 is a transparent piece;
a second display panel 22, where the second display panel 22 is disposed facing away from the first display panel 21, and the second display panel 22 is a transparent piece;
a recognition module 23, where the recognition module 23 is disposed between the first display panel 21 and the second display panel 22; and
a light adjustment piece 24, where the light adjustment piece 24 is disposed between the first display panel 21 and the second display panel 22, and is configured to reflect light entering from the first display panel 21 and the second display panel 22 to the recognition module 23.

Herein, both the first display panel 21 and the second display panel 22 are made of transparent materials, so that both the first display panel 21 and the second display panel 22 can transmit light to implement a function of recognizing biometric information. When biometric information input is detected, a target display panel to which the biometric information input is applied may be controlled to emit light. The target display panel is one of the first display panel 21 and the second display panel 22, so that the light emitted by the target display panel is blocked by a biological body and then reflected to the target display panel. The light adjustment piece 24 reflects light entering from the target display panel to the recognition module 23. The recognition module 23 uses the light reflected by the light adjustment piece 24 to recognize the current biometric information input. In this way, biometric information recognition can be implemented using only one recognition module for two display panels, reducing costs and occupied space.

The recognition module 23 may be, for example, a fingerprint recognition module, a face recognition module, a pupil recognition module, or the like, but is not limited thereto. The fingerprint recognition module is used as an example. When a finger is pressed on the first display panel 21 or the second display panel 22 and fingerprint information input is detected, a target display panel to which the fingerprint information input is applied may be controlled to emit light, and the light emitted by the target display panel is blocked by the finger and then reflected to the target display panel. The light adjustment piece 24 reflects the light entering from the target display panel to the fingerprint recognition module. The fingerprint recognition module can use the light reflected by the light adjustment piece 24 to perform fingerprint recognition on the current fingerprint information input. In this way, fingerprint recognition can be implemented using one recognition module for two display panels, reducing costs and occupied space.

Both the first display panel 21 and the second display panel 22 may be an organic light-emitting diode (OLED) display panels, but are not limited thereto.

Light emitting units of the first display panel 21 and the second display panel 22 may be used as light emitting sources, or separately disposed light emitting units may be used as light emitting sources. For example, when both the first display panel 21 and the second display panel 22 are OLED display panels, self-emitting pixel units of the OLED display panel may be used as light emitting sources. When the biometric information input is detected, a light emitting source of a target display panel to which the biometric information input is applied is controlled to emit light, and the light emitted by the light emitting source is blocked by a biological body and then reflected to the target display panel.

For example, it is assumed that the recognition module 23 is a fingerprint recognition module. As shown in FIG. 2, when a finger is pressed on the first display panel 21, light emitted by a light emitting source 25 of the first display panel 21 is blocked by the finger on the first display panel 21 and then reflected to the first display panel 21. The light adjustment piece 24 changes a transmission path of the light entering from the first display panel 21, to reflect the light entering from the first display panel 21 to the recognition module 23. The recognition module 23 uses the light reflected by the light adjustment piece 24 to perform fingerprint recognition.

Similarly, when a finger is pressed on the second display panel 22, light emitted by a light emitting source 25 of the second display panel 22 is blocked by the finger on the second display panel 22 and then reflected to the second display panel 22. The light adjustment piece 24 changes a transmission path of the light entering from the second display panel 22, to reflect the light entering from the second display panel 22 to the recognition module 23. The recognition module 23 uses the light reflected by the light adjustment piece 24 to perform fingerprint recognition.

The mobile terminal according to the embodiments of this disclosure transmits the light entering from the first display panel 21 and the second display panel 22 to the recognition module through the light adjustment piece 24, so that biometric information recognition (for example, a fingerprint recognition function) can be implemented using one recognition module for two display panels, thereby reducing costs and occupied space.

Optionally, the light adjustment piece 24 includes a first reflection surface 241 and a second reflection surface 242, where the first reflection surface 241 is obliquely disposed toward the first display panel 21, the first reflection surface 241 reflects light entering from the first display panel 21 to the recognition module 23, the second reflection surface 242 is obliquely disposed toward the second display panel 22, and the second reflection surface 242 reflects light entering from the second display panel 22 to the recognition module 23.

In this case, as shown in FIG. 2, the light adjustment piece 24 includes two reflection surfaces, and the first reflection surface 241 is obliquely disposed toward the first display panel 21. The first reflection surface 241 can change a transmission path of the light entering from the first display panel 21, and reflect the light entering from the first display panel 21 to the recognition module 23, to implement a function (for example, a fingerprint recognition function) of recognizing biometric information on the first display panel 21. The second reflection surface 242 is obliquely disposed toward the second display panel 22. The second reflection surface 242 can change a transmission path of the light entering from the second display panel 22, and reflect the light entering from the second display panel 22 to the recognition module 23, to implement a function (for example, a fingerprint recognition function) of recognizing biometric information on the second display panel 22. In this way, biometric information recognition (for example, a fingerprint recognition function) can be implemented using one recognition module for two display panels, reducing costs and occupied space.

Optionally, the recognition module 23 is a fingerprint recognition module. The fingerprint recognition module includes an optical lens 231 and a fingerprint sensor 232, where the optical lens 231 and the fingerprint sensor 232 are disposed between the first display panel 21 and the second display panel 22; and the light adjustment piece 24 is configured to reflect the light entering from the first display panel 21 and the second display panel 22 to the optical lens 231.

In this case, as shown in FIG. 2, the light adjustment piece 24 reflects the light entering from the first display panel 21 and the second display panel 22 to the optical lens 231. The optical lens 231 then transmits the light reflected by the light adjustment piece 24 to the fingerprint sensor 232. The fingerprint sensor 232 uses the light transmitted by the optical lens 231 to perform fingerprint recognition, so that a function of recognizing a fingerprint on dual screens can be implemented through one fingerprint recognition module.

This disclosure does not limit a method for performing fingerprint recognition by the fingerprint sensor 232 through light, and any reasonable method may be used, provided that fingerprint recognition can be implemented.

Optionally, an included angle between the first reflection surface 241 and the first display panel 21 is an acute angle (for example, 45° or 60°), to ensure that the first reflection surface 241 can reflect the light entering from the first display panel 21 to the recognition module 23 located on one side of the first reflection surface 241 and the second reflection surface 242. Optionally, an included angle between the second reflection surface 242 and the second display panel 22 is also an acute angle (for example, 45° or 60°), to ensure that the second reflection surface 242 can reflect the light entering from the second display panel 22 to the recognition module 23 located on one side of the first reflection surface 241 and the second reflection surface 242.

For example, as shown in FIG. 2, the mobile terminal includes the first display panel 21 and the second display panel 22 disposed facing away from each other. Both the first display panel 21 and the second display panel 22 are OLED panels. An included angle between the first reflection surface 241 and the first display panel 21 is 45°, and an included angle between the second reflection surface 242 and the second display panel 22 is also 45°. The recognition module 23 is a fingerprint recognition module. The optical lens 231 and the fingerprint sensor 232 of the recognition module are disposed on one side of the first reflection surface 241 and the second reflection surface 242. In this case, when a finger is pressed on the first display panel 21 or the second display panel 22, light from a light emitting pixel unit of the first display panel 21 or the second display panel 22 is blocked by a fingerprint of the finger and then reflected to the first reflection surface 241 or the second reflection surface 242, then reflected to the optical lens 231, and finally implements fingerprint imaging on the fingerprint sensor 232. In this way, a function of recognizing a fingerprint on the first display panel 21 and the second display panel 22 is implemented through one fingerprint recognition module, reducing costs and occupied space.

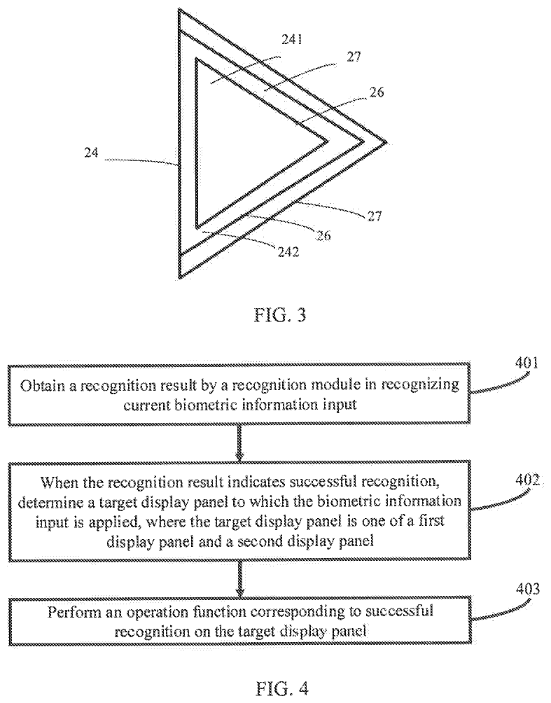

Optionally, as shown in FIG. 3, a reflective material layer 26 is disposed on each of the first reflection surface 241 and the second reflection surface 242.

In this case, the reflective material layers 26 on the first reflection surface 241 and the second reflection surface 242 can reflect the light entering from the first display panel and the second display panel to change a transmission path of the light, so as to reflect the light entering from the first display panel and the second display panel to the recognition module. In this way, biometric information recognition (for example, a fingerprint recognition function) can be implemented using one recognition module for two display panels.

Optionally, the reflective material layer 26 is made of aluminum or mercury, but it is not limited thereto.

Optionally, a transparent material layer 27 is disposed on each of the reflective material layers 26 of the first reflection surface 241 and the second reflection surface 242.

In this case, the transparent material layer 27 can protect the reflective material layer 26. In addition, the transparent material layer 27 can transmit light, so that the light entering from the first display panel can pass through the transparent material layer 27 on the first reflection surface 241, and then is reflected by the reflective material layer 26 at the bottom of the first reflection surface 241. Similarly, the light entering from the second display panel can pass through the transparent material layer 27 on the second reflection surface 242, and then is reflected by the reflective material layer 26 at the bottom of the second reflection surface 242. This does not affect the function of changing light transmission paths of the first reflection surface 241 and the second reflection surface 242.

Optionally, the transparent material layer 27 is made of glass, but it is not limited to thereto.

Optionally, as shown in FIG. 2, the light adjustment piece 24 further includes a bottom surface 243, and the first reflection surface 241, the bottom surface 243, and the second reflection surface 242 are connected in sequence.

In this case, the first reflection surface 241, the bottom surface 243, and the second reflection surface 242 form an integral and stable structure that facilitates installation and removal.

Optionally, the first reflection surface 241, the second reflection surface 242, and the bottom surface 243 form an isosceles triangle.

In this case, the first reflection surface 241, the second reflection surface 242, and the bottom surface 243 form an isosceles triangle, further enhancing the stability of the structure. In addition, symmetry between the first reflection surface 241 and the second reflection surface 242 is beneficial to uniformity of light reflected from the first reflection surface 241 and the second reflection surface 242.

Optionally, there is a hollow structure between the first reflection surface 241 and the second reflection surface 242.

In this case, the hollow structure between the first reflection surface 241 and the second reflection surface 242 reduces mass of the structural and is beneficial to a lightweight design of the terminal.

Alternatively, a filling material is disposed between the first reflection surface 241 and the second reflection surface 242.

In this case, the filling material disposed between the first reflection surface 241 and the second reflection surface 242 further ensures stability of the structure.

Optionally, the filling material is resin, but is not limited thereto.

The optical lens 231 with a sufficiently large area may be selected to ensure that the optical lens 231 can transmit all light reflected by the first reflection surface 241 and the second reflection surface 242 to the fingerprint sensor 232. For example, the selected optical lens 231 at least has an area larger than a projected area of the first reflection surface 241 on a plane where the optical lens 231 is located, and larger than a projected area of the second reflection surface 242 on a plane where the optical lens 231 is located.

A specific application example of the mobile terminal in the embodiments of this disclosure is described as follows.

As shown in FIG. 2, the mobile terminal includes the first display panel 21 and the second display panel 22 disposed facing away from each other. Both the first display panel 21 and the second display panel 22 are OLED panels. The light adjustment piece 24 includes the first reflection surface 241, the second reflection surface 242, and the bottom surface 243 that form an isosceles triangle (a triangular prism). The triangular prism is a hollow prism inside or has a filling material such as resin inside. An included angle between the first reflection surface 241 and the first display panel 21 is 45°, and an included angle between the second reflection surface 242 and the second display panel 22 is also 45°. The reflective material layer 26 and the transparent material layer 27 are disposed on each of the first reflection surface 241 and the second reflection surface 242 in sequence. The reflective material layer 26 is made of aluminum with a strong light-reflecting ability. The recognition module 23 is a fingerprint recognition module. The optical lens 231 and the fingerprint sensor 232 of the fingerprint recognition module are disposed on one side of the light adjustment piece 24. In addition, an area of the optical lens 231 is larger than a projected area of the first reflection surface 241 on a plane where the optical lens 231 is located, and larger than a projected area of the second reflection surface 242 on a plane where the optical lens 231 is located.

As shown in FIG. 2, when a finger is pressed on the first display panel 21, light emitted by a light emitting pixel unit of the first display panel 21 is blocked by the finger and then reflected into the terminal. The first reflection surface 241 changes a transmission path of the light entering from the first display panel 21 and reflects the light to the optical lens 231, and finally fingerprint imaging is implemented on the fingerprint sensor 232. Similarly, when a finger is pressed on the second display panel 22, light emitted by a light emitting pixel unit of the second display panel 22 is blocked by the finger and then reflected into the terminal. The second reflection surface 242 changes a transmission path of the light entering from the second display panel 22 and transmits the light to the optical lens 231, and finally fingerprint imaging is implemented on the fingerprint sensor 232. In this way, a function of recognizing a fingerprint on dual screens is implemented through one fingerprint recognition module.

In conclusion, the mobile terminal according to the embodiments of this disclosure transmits the light entering from the first display panel and the second display panel to the recognition module through the light adjustment piece, so that biometric information recognition (for example, a fingerprint recognition function) can be implemented using one recognition module for two display panels, thereby reducing costs and occupied space.

In some embodiments of this disclosure, as shown in FIG. 4, a recognition method applied to the mobile terminal according to any one of the above is further provided, including the following steps.

Step 401: Obtain a recognition result by the recognition module of in recognizing current biometric information input.

Herein, the result of recognizing the biometric information input is obtained to verify an identity of a user, thereby ensuring legality and security of an operation. The recognition module can recognize biometric information based on the light, entering from the first display panel and the second display panel, reflected by the light adjustment piece.

Step 402: When the recognition result indicates successful recognition, determine a target display panel to which the biometric information input is applied, where the target display panel is one of the first display panel and the second display panel.

In the embodiments of this disclosure, with the light adjustment piece, biometric information on dual screens can be recognized by using one recognition module. In other words, the light adjustment piece can reflect the light entering from the first display panel and the second display panel to the recognition module, and the recognition module can implement, based on the reflected light, a biometric information recognition function.

Since the recognition module can receive the light from both the first display panel and the second display panel, when the recognition succeeds, it is necessary to determine which display panel the biometric information input comes from. Herein, the determining a target display panel to which the biometric information input is applied can accurately and quickly determine which display panel the biometric information input comes from.

Step 403: Perform an operation function corresponding to successful recognition on the target display panel.

Herein, when a user enters the biometric information input on the first display panel, the first display panel is the target display panel, and when the user enters the biometric information input on the second display panel, the second display panel is the target display panel. When the recognition succeeds, the operation function (for example, unlocking a screen) corresponding to successful recognition is implemented on the target display panel (the first display panel or the second display panel), so that biometric information recognition and screen control functions can be implemented using one recognition module for dual screens.

According to the fingerprint recognition method in the embodiments of this disclosure, biometric information recognition can be implemented using one recognition module for two display panels, so as to implement screen control by using the biometric information on the two display panels, thereby reducing costs and occupied space.

Optionally, before step 401, the following is further included:
controlling the target display panel to which the biometric information input is applied to emit light, so that the light emitted by the target display panel is blocked by a biological body and then reflected to the target display panel, and the light adjustment piece reflects light entering from the target display panel to the recognition module.

In this case, when the biometric information input is detected, the target display panel to which the biometric information input is applied may be controlled to emit light. The target display panel is one of the first display panel and the second display panel, so that the light emitted by the target display panel is blocked by a biological body and then reflected to the target display panel. The light adjustment piece reflects the light entering from the target display panel to the recognition module. The recognition module uses the light reflected by the light adjustment piece to recognize the current biometric information input. In this way, biometric information recognition can be implemented using one recognition module for on two display panels, reducing costs and occupied space.

It should be noted that in this specification, the terms “include” and “comprise”, or any of their variants are intended to cover a non-exclusive inclusion, such that a process, a method, an article, or an apparatus that includes a list of elements not only includes those elements but also includes other elements that are not expressly listed, or further includes elements inherent to such a process, method, article, or apparatus. In absence of more constraints, an element preceded by “includes a . . . ” does not preclude the existence of other identical elements in the process, method, article, or apparatus that includes the element.

According to the foregoing description of the implementations, a person skilled in the art may clearly understand that the methods in the foregoing embodiments may be implemented by using software in combination with a necessary common hardware platform, and certainly may alternatively be implemented by using hardware. However, in most cases, the former is a preferred implementation. Based on such an understanding, the technical solutions of this disclosure essentially or a part thereof that contributes to related technologies may be embodied in a form of a software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this disclosure.

The embodiments of this disclosure are described above with reference to the accompanying drawings, but this disclosure is not limited to these embodiments. These embodiments are only illustrative rather than restrictive. Inspired by this disclosure, a person of ordinary skill in the art can still derive a plurality of variations without departing from the essence of this disclosure and the protection scope of the claims. All these variations shall fall within the protection of this disclosure.

What is claimed is:

1. A mobile terminal, comprising:
a first display panel, wherein the first display panel is a transparent piece;
a second display panel, wherein the second display panel is disposed facing away from the first display panel, and the second display panel is a transparent piece;
a recognition module, wherein the recognition module is disposed between the first display panel and the second display panel; and
a light adjustment piece, wherein the light adjustment piece is disposed between the first display panel and the second display panel, and is configured to reflect light entering from the first display panel and the second display panel to the recognition module.

2. The mobile terminal according to claim 1, wherein the light adjustment piece comprises a first reflection surface and a second reflection surface, the first reflection surface is obliquely disposed toward the first display panel, the first reflection surface reflects light entering from the first display panel to the recognition module, the second reflection surface is obliquely disposed toward the second display panel, and the second reflection surface reflects light entering from the second display panel to the recognition module.

3. The mobile terminal according to claim 2, wherein a reflective material layer is disposed on each of the first reflection surface and the second reflection surface.

4. The mobile terminal according to claim 3, wherein the reflective material layer is made of aluminum or mercury.

5. The mobile terminal according to claim 3, wherein a transparent material layer is disposed on each of the reflective material layers of the first reflection surface and the second reflection surface.

6. The mobile terminal according to claim 5, wherein the transparent material layer is made of glass.

7. The mobile terminal according to claim 2, wherein the light adjustment piece further comprises a bottom surface, and the first reflection surface, the bottom surface, and the second reflection surface are connected in sequence.

8. The mobile terminal according to claim 7, wherein the first reflection surface, the bottom surface, and the second reflection surface form an isosceles triangle.

9. The mobile terminal according to claim 2, wherein a hollow structure is formed between the first reflection surface and the second reflection surface, or a filling material is disposed between the first reflection surface and the second reflection surface.

10. The mobile terminal according to claim 9, wherein the filling material is resin.

11. The mobile terminal according to claim 1, wherein the recognition module is a fingerprint recognition module.

12. The mobile terminal according to claim 11, wherein the fingerprint recognition module comprises an optical lens and a fingerprint sensor, and the optical lens and the fingerprint sensor are disposed between the first display panel and the second display panel; and
the light adjustment piece is configured to reflect the light entering from the first display panel and the second display panel to the optical lens.

13. A recognition method applied to the mobile terminal according to claim 1, wherein the method comprises:
obtaining a recognition result by the recognition module in recognizing current biometric information input;
when the recognition result indicates successful recognition, determining a target display panel to which the biometric information input is applied, wherein the target display panel is one of the first display panel and the second display panel; and
performing an operation function corresponding to successful recognition on the target display panel.

14. The recognition method according to claim 13, before the obtaining a recognition result by the recognition module of in recognizing current biometric information input, further comprising:
controlling the target display panel to which the biometric information input is applied to emit light, so that the light emitted by the target display panel is blocked by a biological body and then reflected to the target display panel, and the light adjustment piece reflects light entering from the target display panel to the recognition module.
